(19) United States
(12) Patent Application Publication
(10) Pub. No.: US 2013/0135535 A1
(43) Pub. Date: May 30, 2013

(54) METHOD AND APPARATUS FOR FAST CHANNEL CHANGE

(71) Applicant: Curtis Ling, Carlsbad, CA (US)

(72) Inventor: Curtis Ling, Carlsbad, CA (US)

(21) Appl. No.: 13/687,133

(22) Filed: Nov. 28, 2012

Related U.S. Application Data
(60) Provisional application No. 61/565,032, filed on Nov. 30, 2011.

(51) Int. Cl. H04N 5/50

(52) U.S. Cl. CPC H04N 5/50
USPC 348/731

(57) ABSTRACT

A device operable to handle channelized media content may generate a prediction that a first channel will be selected for presentation based on a partially-input channel identifier. The device may process the first channel while concurrently processing a second channel, the second channel having been previously selected for presentation. The prediction may be updated upon input of each character of the channel identifier. The prediction may be based on a position of a user's finger on a remote control and/or based on channels being consumed by consumers in a common demographic with the user. The processing of the first channel may comprise partially decoding the first channel and buffering the partially-decoded first channel. Upon said first channel being selected for presentation, the device may read the partially-decoded first channel from memory, further decode the partially-decoded first channel to recover content, and outputting the recovered content.

### CLAIM OF PRIORITY

This patent application makes reference to, claims priority to and claims benefit from U.S. Provisional Patent Application Ser. No. 61/565,032 entitled “Method and System for Fast Television Channel Change” and filed on Nov. 30, 2011.

The above-identified application is hereby incorporated herein by reference in its entirety.

### INCORPORATION BY REFERENCE

This patent application also makes reference to:
U.S. patent application Ser. No. 13/485,003 entitled “Multi-layer Time-Interleaved Analog-to-Digital Converter (ADC),” and filed on May 31, 2012; and
U.S. patent application Ser. No. 13/326,125 entitled “System and Method in a Broadband Receiver for Efficiently Receiving and Processing Signals” and filed on Dec. 14, 2011;

Each of the above stated applications is hereby incorporated herein by reference in its entirety.

### FIELD

Certain implementations of this disclosure relate to reception and processing of channelized content. More specifically, certain implementations of this disclosure relate to a method and system for fast channel change.

### BACKGROUND

Satellite and cable television as well as streaming media services have become ubiquitous in most homes, most of which may have hundreds of channels available. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY

A method and/or system is provided for fast channel change, substantially as illustrated by and/or described in connection with at least one of the figures, as set forth more completely in the claims.

### BRIEF DESCRIPTION OF SEVERAL VIEWS OF THE DRAWINGS

FIG. 1 is a block diagram of an example system for receiving channelized media in accordance with an implementation of this disclosure.

FIG. 2 is a diagram illustrating example receive circuitry with support for fast channel selection, in accordance with an implementation of this disclosure.

FIG. 3 is a diagram illustrating an example remote control with support for fast channel selection, in accordance with an implementation of this disclosure.

FIG. 4 is a diagram illustrating an example fast television channel selection, in accordance with an implementation of this disclosure.

FIG. 5 is a flow diagram illustrating an example fast television channel selection for content from a server, in accordance with an implementation of this disclosure.

FIG. 6 is a flow diagram illustrating an example fast channel selection with reduced resolution channel data, in accordance with an implementation of this disclosure.

FIG. 7 is a flow diagram illustrating fast channel selection based on sensors in a remote control, in accordance with an implementation of this disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled by some user-configurable setting.

In existing digital video systems, channel change latency is a significant concern because viewers want to watch and listen to content—they don't want to watch blank screens and/or listen to silence for extended periods of time (even a second or less can feel like a lot of time when changing channels). The latency between a user inputting a channel change request and the content of the new channel beginning to be presented to the user may result from, for example, downconverting, demodulating, decoding, descrambling, decompressing, and/or otherwise processing the received electromagnetic signal carrying the content. Aspects of the invention work to mask some or all of this latency. In satellite television systems, there may additionally be some latency resulting from a need to reconfigure a LNB to select a different satellite.

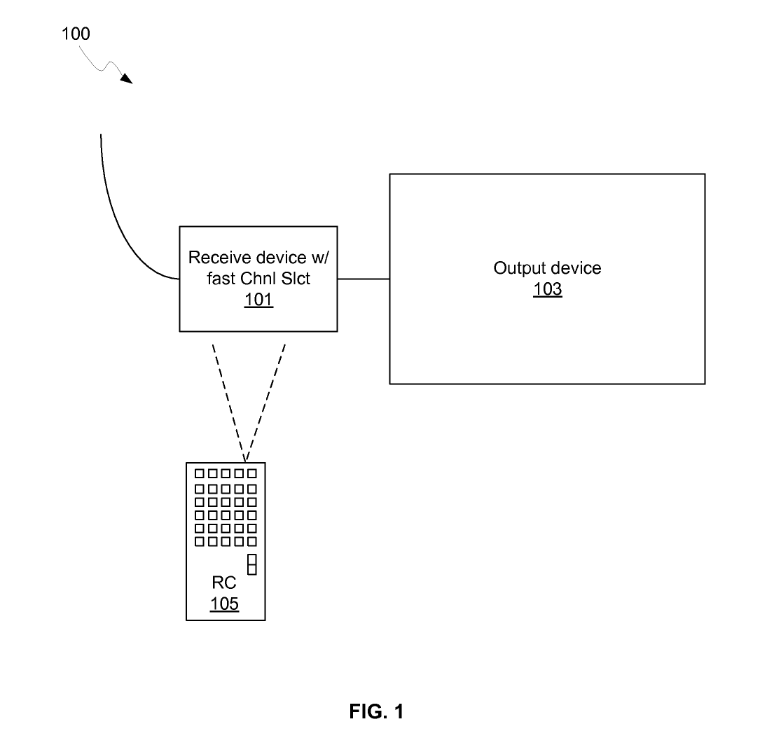

FIG. 1 is a block diagram of an example system for receiving channelized media in accordance with an implementation of this disclosure. Referring to FIG. 1, there is shown a receive device 101 with fast channel select capabilities, output device(s) (e.g., monitor and/or speakers) 103, and a remote control 105.

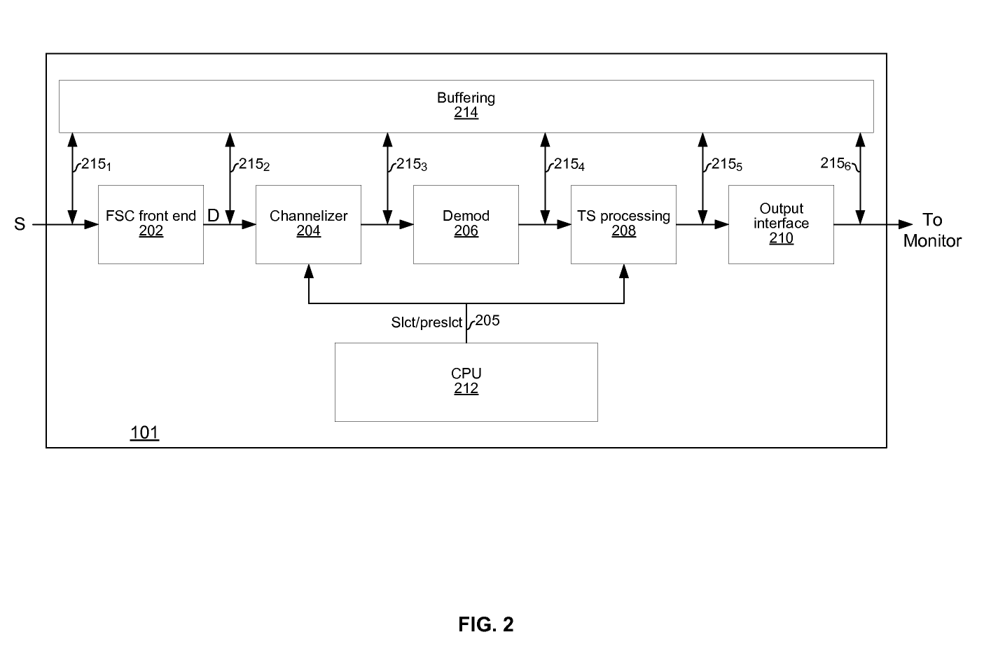

The receive device 101 may comprise circuitry for receiving a first signal comprising one or more channels (e.g., cable television signal, satellite television signal, DOCSIS signal, DSL signal, process one or more channels of the first signal to recover content carried in the channel(s), embed the recovered content in a second signal (e.g., HDMI, analog video, analog audio), and output the second signal. As utilized herein, the “selected” channel is the channel that has been selected for presentation. That is, the channel whose content is being recovered from the first signal and output in the second signal. As utilized herein, a “preselected” channel is a channel that is being processed (e.g., downconverted, demodulated, decoded, and/or decompressed) in the background (e.g., by redundant circuitry and/or time-shared circuitry in the device 101) such that its content may be quickly available should it become the selected channel. A selected or preselected channel selection may correspond to a particular frequency sub-band (e.g., a sub-band within the cable or satellite spectrum), or may be a particular digital file available for streaming a network device. An example implementation of the device 101 is described below with reference to FIG. 2.

The output device 103 may comprise circuitry for receiving the second signal, processing the second signal to recover the content, and presenting the content via a screen and/or speakers. Although the receive device 101 and output device 103 are depicted as separate devices in the implementation shown, they may be integrated into a single device in other implementations. Additionally or alternatively, the receive device 101, or portions thereof, herein may be implemented in an “Internet Protocol LNB” as described, for example, in U.S. patent application Ser. No. 13/326,125, which is hereby incorporated herein by reference. Thus, circuitry for performing various functions described in this disclosure may reside in one of, or be distributed among, several possible locations: (1) the premise (e.g., a set top box, gateway, television, PVR, computer, tablet device, cell phone, or switching device within the house, apartment, office); (2) an outdoor unit (e.g., a low-noise block down-converter (LNB), channel stacking or band stacking device, or IP-LNB residing at a satellite dish, antenna, roof top or box sitting outside the house); and/or (3) a cloud device such as a server, server farm, or storage device attached to a local area network, WAN, or the Internet (in which case the RF channel selection and other PHY processing is replaced by relaying of channel requests to the cloud device for downloading and processing, e.g. partial decoding).

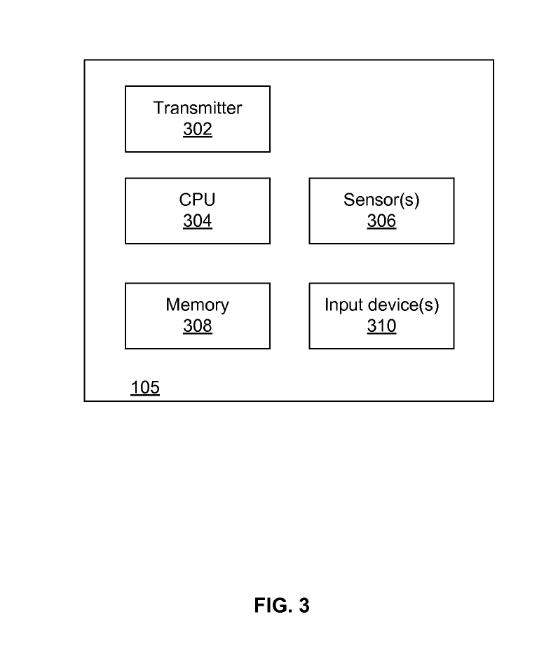

The remote control 105 may comprise circuitry for communicating with the receive device 101 to control which channel is selected in the receive device 101. The remote control 105 may be a multi-function device such as, for example, a smartphone or tablet. The remote control may, for example, accept tactile input (e.g., via hard buttons and/or a touchscreen), voice input (e.g., via a microphone), visual input (e.g., detect gestures via a camera and/or motion sensor), motion/orientation input (e.g., via a gyroscope and/or accelerometer), breath, and/or any other type of input. An example implementation of the remote control 105 is described below with reference to FIG. 3.

In an example implementation, the receive device 101 may be operable to preselect one or more channels such that, should one of the preselected channels be selected by a user, the latency between the channel change request and the channel being presented to the user will be reduced or eliminated. Whether a particular channel is preselected may be based on a probability that a user will select that particular channel in the near future. The channel(s) may be preselected based on, for example, a partial channel identifier (e.g., where the user is in the process of inputting the channel identifier), based on past media consumption by the current user and/or other users, based on the relative location of the channel in a sorted list (e.g., preselect a next-higher numbered channel and next lower-numbered in the user's favorites list, in anticipation of user touching, saying, or gesturing “channel up” or “channel down”) and/or based on sensor input from the remote control 105.

In an example scenario, which one or more channels are preselected in the set receive device 101 may be updated as soon as the user begins to enter (e.g., via buttons, voice, gestures, movements, etc.) a channel identifier on the remote control 105. In other words, which channel(s) are preselected may be updated as each character (letter, number, or symbol) of the channel identifier is enter. Because the user typically enters a channel identifier at a limited speed, the system uses the time between characters to narrow down the list of possible channels to be selected. For television, a channel identifier may typically be a channel number. For streaming content, a channel identifier may be, for example, a URL.

For example, if a user desires to watch channel “189,” s/he begins by inputting “1.” In response to the “1” being entered (or upon a prediction, based on sensor information, that a “1” is about to be entered) the receive device 101 may preselect channels that begin with “1,” such as 1, 11-19, and 100-199, for example (and in a satellite system, may signal the LNB to select the satellite(s) that carry one or more of channels 1, 11-19, and 100-199). Then, upon the user entering the “8” (or upon a prediction, based on sensor information, that an “8” is about to be entered) the preselected channels may be further narrowed to channels 180-189. A prediction that a character is about to be entered may, for example, be based on: a user's finger being in proximity to a corresponding button or touchscreen element; the first syllable(s) of a corresponding voice command; initial positioning and/or initial movement of a corresponding gesture or movement of the remote control. In instances where the number of preselected channels that the receive device 101 can concurrently process is less than the number of possible channels to be selected (e.g., less than the 110 channels that have an identifier beginning with “1”), then the preselected channel(s) may be chosen from the list of possible channels based on other information that may have a statistically significant correlation to predicting the channel to be selected. Such information may include, for example, recently-consumed channels, recently-consumed content and/or genre of content (e.g., “sports” or “football”), the identity of the current user, the current user's media consumption habits, and/or a broader audience's media consumption habits (e.g., what is popular among other users in a same demographic). The identity of the user may be determined, for example, via biometric sensors of the remote control 105 and/or receive device 101, and/or based on the user selecting his/her profile (e.g., via a press of one or more button or via a particular gesture). The user's media consumption habits may include, for example, favorite channel(s), favorite actor(s), favorite content, favorite type of content, and/or what media the user typically consumes at particular times. In an example implementation, commonly selected channels may be automatically preselected, until such time as the channel is excluded by an entered character of the channel identifier and/or until the probability that the channel will be selected drops below a threshold.

The information used in determining the channel(s) to be preselected may be stored in the remote 105, in the receive device 101, and/or in another network location. The determination of which channel(s) are to be preselected may be performed in the remote control 105, in the receive device 101, and/or may be distributed among the device 101 and the remote control 105.

FIG. 2 is a diagram illustrating an example receive device with fast channel selection, in accordance with an implementation of this disclosure. The example receive device 101 comprises a full-spectrum capture (“FSC”) front-end 202, a channelizer 204, demodulator(s)/decoder(s) 206, transport stream processor 208, an output interface 210, a central processing unit (CPU) 212, and buffer(s) 214.

The buffer(s) 214 may be operable to buffer signals at any stage along the processing path of the receive device 101, as indicated by the arrows 215.

The FSC front-end 202 may comprise circuitry operable to downconvert and/or digitize the entire bandwidth, from Fₗₒ to Fₕᵢ, of a received signal S. An example implementation of the FSC front-end 202 may operate as follows. The received signal S (e.g., a CATV signal from a cable head-end, a received signal from a satellite, or a down-converted satellite signal from a LNB) may be amplified by an amplifier to generate S′. The amplified signal S′ may be filtered by a filter to remove undesired signals outside of Fₗₒ to Fₕᵢ and generate a signal S″. The signal S″, from Fₗₒ to Fₕᵢ, may then be digitized by an ADC to generate a signal D. In an example implementation, the ADC may be as described in U.S. patent application Ser. No. 13/485,003 entitled “Multi-layer Time-Interleaved Analog-to-Digital Converter (ADC),” which is incorporated by reference herein. In an example implementation, the ADC may be capable of digitizing a signal S″ wherein Fₗₒ to Fₕᵢ is 1 GHz or higher. Accordingly, for cable television/DOCSIS, the ADC may be operable to digitize the entire cable downstream (e.g., from ˜55 MHz to ˜1002 MHz). Similarly, for satellite television, the ADC may be operable to digitize the received signal at the input of the LNB, and/or the downconverted signal (e.g., from ˜1 GHz to ˜2 GHz) at the output by an LNB.

The channelizer 204 may comprise circuitry operable to select one or more channels of the digitized signal D for output to the demodulator(s) 206. The channelizer 204 may be as described in, for example, U.S. patent application Ser. No. 13/326,125 entitled “System and Method in a Broadband Receiver for Efficiently Receiving and Processing Signals,” which is incorporated by reference herein. Which channel(s) are output may be controlled based on the signal 205 from the CPU 212. The signal 205 may also indicate which of the channels is to be output as the selected channel and which is/are to be output as the preselected channel(s).

The demodulator(s) 206 may comprise circuitry operable to demodulate (e.g., downconvert, deinterleave, error correct, and descramble) the channel(s) conveyed to it by the channelizer 204. In an example implementation, the demodulator(s) 206 may be capable of concurrently demodulating N (an integer number) channels. One of the N channels may be the selected channel and the remaining N−1 channels may be preselected channels. In an example implementation, the preselected channels may be output to the buffer 214 (e.g., along the path indicated by arrow 215₄) while the selected channel may be output to the transport stream TS processor 208. In another example implementation, both the demodulated selected channel and the demodulated preselected channel(s) may be output to the TS processor 208.

The transport stream (TS) processor 208 may comprise circuitry operable to decode (e.g., H.264 decoding) the selected channel and to decode (at least partially) the preselected channel(s). In an example implementation, selected channel may be fully decoded and preselected channel(s) may be partially decoded. In such an implementation, desired transport stream(s) of the decoded, selected channel may be output to the output interface 210 while the partially decoded preselected channel(s) may be output to buffer(s) 214 (e.g., along the path indicated by arrow 215₅). In such an implementation, upon a preselected channel becoming the selected channel, the partially-decoded version of that channel may be read from buffer 214 back into the TS processor 208 (e.g., along the path indicated by arrow 215₄) where decoding may be quickly completed before outputting the demodulated and decoded channel to the output interface 210. In another example implementation, the each selected channel and the preselected channel(s) may be fully decoded and output to buffer 214, then upon a preselected channel becoming the selected channel, the output interface 210 simply needs to change which portion of the buffer(s) 214 that is reads from.

The output interface 210 may comprise circuitry operable to encode, modulate, amplify, and/or otherwise process one or more transport streams for output to a monitor. For example, the output interface 210 may process a transport stream and output it in accordance with the HDMI and/or DisplayPort standards.

The CPU 212 may comprise circuitry operable to control the general operation of the receive device 101 and to determine which channel(s) are to be preselected. The CPU 212 may also comprise a security processor for receiving subscription or update information from the headend or satellite provider.

FIG. 3 is a diagram illustrating an example remote control with support for fast channel selection, in accordance with an implementation of this disclosure. The example remote control 105 comprises a transmitter 302, a CPU 304, sensor(s) 307, memory 308, and input device(s) 310.

The transmitter 302 may comprise circuitry operable to transmit messages suitable formatted for reception by the receive device 101. The transmitter 302 may transmit, for example infrared and/or RF signals.

The CPU 304 may comprise circuitry operable to control the general operation of the remote control 105 and to determine which channels are to be preselected.

The memory 308 may comprise circuitry operable to store data. The memory 308 may comprise program memory, run-time memory, and/or mass storage. In an example implementation, the memory 308 may store instructions, to be executed by the CPU 304, for determining which channel(s) are to be preselected and/or information used in determining which channel(s) are to be preselected.

The sensor(s) 307 may comprise circuitry for detecting conditions of the remote control 105 and/or its surrounding environment. The sensor(s) 307 may comprise, for example, a light sensor, a temperature sensor, a motion sensor, accelerometer, gyroscope, and/or a camera. In an example implementation, the sensor(s) 307 may be operable to detect the position of a user's finger, stylus, cursor, or other input implement.

The input device(s) 310 may comprise, for example, a hard keypad and/or virtual keypad displayed on a touchscreen.

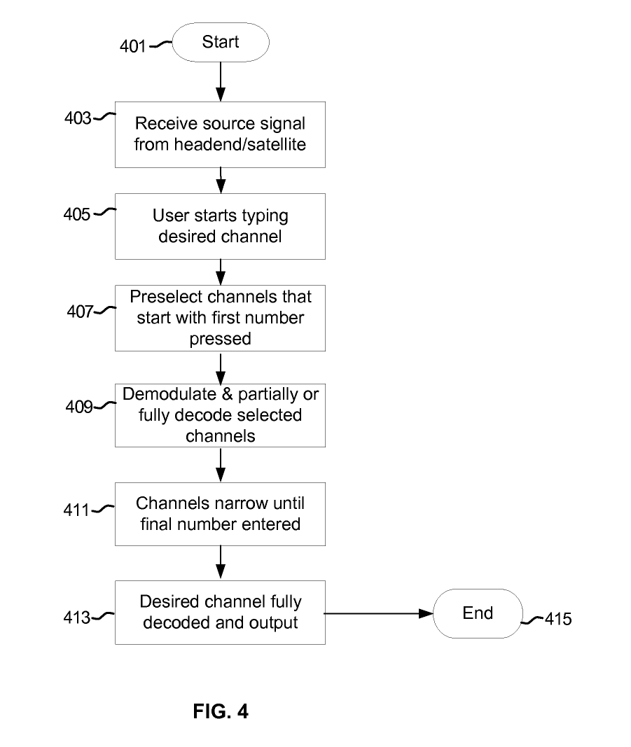

FIG. 4 is a diagram illustrating an example fast television channel selection, in accordance with an implementation of this disclosure. Referring to FIG. 4, in block 403, after start block 401, a source signal may be received by an RF front-end (e.g., the FSC front-end 202). In block 405, a user may input a first character of the channel identifier of a desired channel, followed by block 407 where all channels that start with that character are preselected. Where all the possible channels to be selected (channels starting with the character entered by the user) cannot be concurrently preselected, channels that are commonly watched by the user and/or that have a higher probability of being selected (e.g., based on the user's content consumption habits) may be preselected over other channels having the same first character in their identifier but which are less probable to be selected. In block 409, the preselected channels may be further processed, such as amplified, filtered, converted to digital signals, demodulated, and partially decoded. The extent to which the preselected channels are processed may depend on available resources (e.g., power consumption and/or bandwidth in one or more of the components of the receive device 101). In block 411, the list of possible channels to be selected is pared down as the user enters subsequent characters of the channel identifier, until block 413 when the channel identifier of the desired channel is fully entered. The process completes with bock 415.

Returning to block 409, as the list of possible channels to be selected is pared down, the number of preselected channels may be decreased once the number of possible channels is reduced below the maximum number of channels that can be concurrently preselected. In this manner, power savings may be realized and/or resources may be freed up for performing other tasks. During periods when a user is not inputting a channel identifier, the number channels that are preselected may be chosen to optimize a trade-off between speed or channel changes on one hand and power and resource consumption on the other.

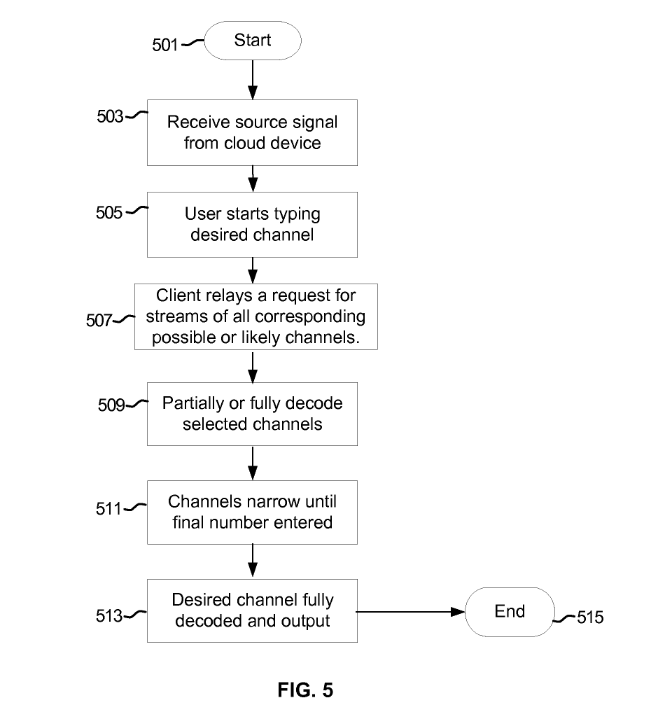

FIG. 5 is a flow diagram illustrating an example fast television channel selection for content from a server, in accordance with an implementation of this disclosure. Referring to FIG. 5, in block 503, after start block 501, a source signal may be received from a cloud device and/or a LAN/WAN server. In block 505, a user may start inputting a channel identifier a desired channel, followed by block 507 in which all corresponding possible channels may be preselected by a client requesting that the content of such channels be streamed to the client. Where the number of possible channels is greater than can be streamed, channels that are commonly watched by the user and/or that have a higher probability of being selected (e.g., based on the user's content consumption habits) may be preselected over other channels having the same first character in their identifier but which are less probable to be selected. In block 509, the preselected channels may be further processed, such as partially or fully decoded, depending on available resources. In block 511, the list of possible channels to be selected is pared down as the user enters subsequent characters of the channel identifier, until block 513 when enough characters of the channel identifier have been entered so as to uniquely identify a particular channel. The process completes with block 515.

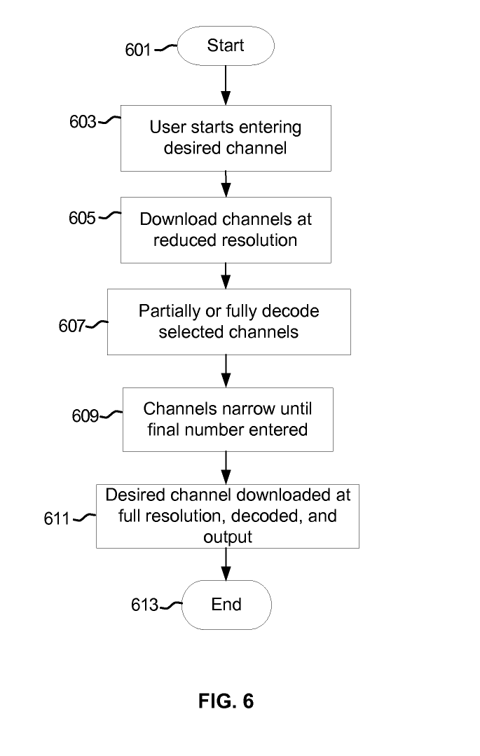

FIG. 6 is a flow diagram illustrating an example fast channel selection with reduced resolution channel data, in accordance with an implementation of this disclosure. The process described in FIG. 6 may comprise a reduced resolution channel selection process that may be utilized in connection with the implementations described with respect to FIGS. 4, 5 and 7, for example. Referring to FIG. 6, in block 603, after start block 601, a user may begin entering a desired channel into a channel selection device (e.g., remote control 105) that controls a receiving device (e.g., receive device 101).

In block 605, a subset of channels, as narrowed down by the selection of the first channel, may be communicated to or downloaded by the receiving device at a reduced resolution. For example, standard definition data may be communicated or downloaded as opposed to full high-definition data. Similarly, the channels immediately above and below the current channel or the last viewed channel may be communicated or downloaded continuously, or until excluded by a channel selection character.

The reduced resolution channels may be partially or fully decoded in block 607 followed by block 609 where the channels are narrowed further until a sufficient portion of the channel identifier so as to make it unique is entered. In block 611, the final desired channel may be communicated or downloaded at full resolution, decoded, and output to the displaying device.

This process of communicating or downloading possible channels at a reduced bit rate reduces bandwidth requirements and enables increased channel selection speed, or “channel surfing” as adjacent or expected channels may be continuously communicated or downloaded at a reduced resolution. In an example MPEG scenario, for example, p-frames may be communicated or downloaded at full resolution while content frames may be communicated or downloaded at a lower resolution until the entered channel identifier is unique. Once final channel identification or selection occurs, however, content frames may then be communicated or downloaded at full resolution. In an example implementation, the concept of Scalable Video Coding (SVC) in H.264 may be used to accommodate lower spatial quality bitstreams (i.e., to support the lower resolution communication or download).

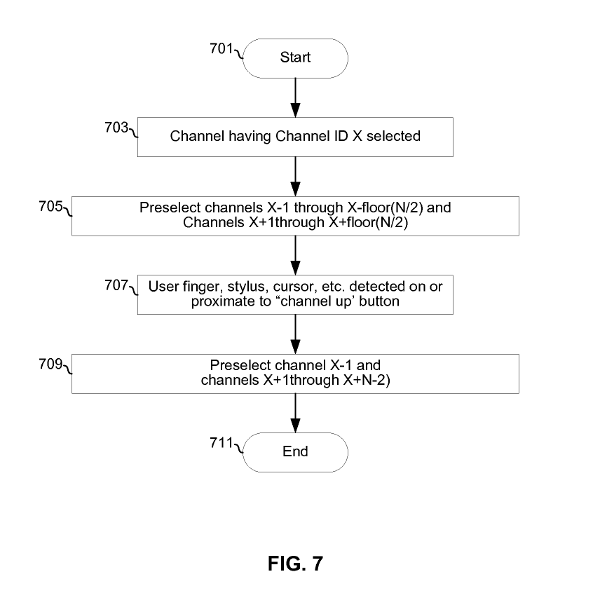

FIG. 7 is a flow diagram illustrating fast channel selection based on sensors in a remote control, in accordance with an implementation of this disclosure. In block 703, after start block 701, a channel having a channel identifier of “X” is selected in the receive device 101. In block 705, a list of one or more channels that are likely to be selected is determined by the device 101 and/or the device 105 and one or more of those channels are preselected in the device 101. In the example implementation of FIG. 7, channels adjacent to channel “X” may be preselected based on the user's “channel surfing” using “channel up” and “channel down” buttons of the remote control 105. Assuming N (an integer) channels can be preselected, the preselected channels in block 705 are N/2−1 channels above channel “X” (channels which can be designated with the notation “X+1” through “X+floor(N/2)” in the instance that the range does not wrap from the highest channel to the lowest channel), and N/2−1 channels below channel “X” (channels which can be designated with the notation “X−1” through “X−floor(N/2)” in the instance that the range does not wrap from the lowest channel to the highest channel).

In block 707, it is determined that the user is likely to press the “channel up” button. In an example implementation, the determination may be made in response to detecting a location of an input implement (e.g., the user's finger, or a stylus, or a mouse cursor). For example, that the user's finger is resting on, or proximate to, the “channel up” button may be detected via an optical or thermal sensor in the remote 105, even though the button is not currently being pressed/tapped/etc. As another example, the location of the user's finger may be determined to be near the “channel up” based on a capacitance, inductance, and/or resistance near the “channel up” button on a touchscreen being between (1) a first capacitance corresponding to there being nothing touching or near the touchscreen; and (2) a second capacitance corresponding to the touchscreen being touched with a finger or stylus. As another example, the location of the user's finger may be determined to be on the “channel up” button based on the fact that the “channel up” button is being held down (or, for a touchscreen, that the user's finger remains in contact with the “channel up” icon). In such an implementation, a channel selection signal may be transmitted from the remote only upon a button transitioning from an unpressed/untouched state to a pressed/touched state. That is, holding the button down may not trigger an increment of the selected channel, but may be used as an indicator that the user will again press the “channel up” button.

Accordingly, aspects of this disclosure may be realized in hardware, software, firmware or a combination thereof. This disclosure may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One implementation of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain implementations, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular implementation disclosed, but that the present invention will include all implementations falling within the scope of the appended claims.

What is claimed is:

1. A method comprising:
in a device operable to handle channelized media content:
generating a prediction that a first channel will be selected for presentation based on a partially-input channel identifier; and
processing said first channel while concurrently processing a second channel, said second channel having been previously selected for presentation.

2. The method of claim 1, comprising updating said prediction upon input of each character of said channel identifier.

3. The method of claim 1, comprising generating said prediction based on a position of a user's finger on a remote control, said position determined via one or more sensors of said remote control.

4. The method of claim 3, wherein said one or more sensors comprise a thermal and/or optical sensor.

5. The method of claim 1, comprising generating said prediction based on a determination of which button of a remote control a user's finger is closest to.

6. The method of claim 1, wherein said processing of said first channel comprises partially decoding said first channel and buffering said partially-decoded first channel.

7. The method of claim 6, comprising, upon said first channel being selected for presentation:
reading said partially-decoded first channel from memory;
further decoding said partially-decoded first channel to recover content carried on said first channel; and
outputting said recovered content.

8. The method of claim 1 comprising generating said prediction based on channels being consumed by consumers in a common demographic with a user of said device.

9. A system comprising:
circuitry operable to:
generate a prediction that a first channel will be selected for presentation based on a partially-input channel identifier; and
process said first channel while concurrently processing a second channel, said second channel having been previously selected for presentation.

10. The system of claim 9, wherein said circuitry is operable to update said prediction upon input of each character of said channel identifier.

11. The system of claim 9, wherein said circuitry is operable to generate said prediction based on a position of a user's finger on a remote control, said position determined via one or more sensors of said remote control.

12. The system of claim 11, wherein said one or more sensors comprise a thermal and/or optical sensor.

13. The system of claim 9, wherein said circuitry is operable to generate said prediction based on a determination of which button of a remote control a user's finger is closest to.

14. The system of claim 9, wherein said processing of said first channel comprises partially decoding said first channel and buffering said partially-decoded first channel.

15. The system of claim 14, wherein said circuitry is operable to, upon said first channel being selected for presentation:
read said partially-decoded first channel from memory;
further decode said partially-decoded first channel to recover content carried on said first channel; and
output said recovered content.

16. The system of claim 9 wherein said circuitry is operable to generate said prediction based on channels being consumed by consumers in a common demographic with a user of said device.

17. A system comprising:
circuitry operable to:
determine which button of a remote control a user is going to press next based on a sensor of said remote control;
generate a prediction that a first channel will be selected for presentation based on said determined button and based on a partially-input channel identifier; and
process said first channel while concurrently processing a second channel, said second channel having been previously selected for presentation.

18. The system of claim 9, wherein said circuitry is operable to update said prediction upon input of each character of said channel identifier.

19. The system of claim 17, wherein said one or more sensors comprise a thermal and/or optical sensor.

20. The system of claim 17, wherein said processing of said first channel comprises partially decoding said first channel and buffering said partially-decoded first channel.
